(19) United States
(12) Patent Application Publication
(10) Pub. No.: US 2026/0163345 A1
(43) Pub. Date: Jun. 11, 2026

(54) CORD HOLDER

(71) Applicant: Midwest Innovative Products, LLC, Joliet, IL (US)

(72) Inventors: Bryan Nooner, Joliet, IL (US); Robert Zajeski, Homer Glen, IL (US)

(21) Appl. No.: 19/414,695

(22) Filed: Dec. 10, 2025

Related U.S. Application Data
(60) Provisional application No. 63/730,734, filed on Dec. 11, 2024.

(51) Int. Cl. H02G 3/04; B65H 54/60

(52) U.S. Cl. CPC H02G 3/0456; B65H 54/60; B65H 2701/34

(57) ABSTRACT

A cord holder for a cord includes: a base; a first winding arm; and a second winding arm, wherein the second winding arm is rotatable between a collapsed position, a cord-winding position, and a cord-removal position, wherein the first winding arm and the second winding arm, when in its cord-winding position, are configured to receive the cord such that the cord winds around the first winding arm and the second winding arm.

### CROSS REFERENCE TO RELATED APPLICATIONS

This application claims the benefit of U.S. Prov. No. 63/730,734, filed on Dec. 11, 2024, the entirety of which is herein incorporated by reference in its entirety.

### BACKGROUND

Generally, this application relates to devices for winding cords.

### SUMMARY

According to embodiments cord holder for a cord includes: a base; a first winding arm having a first end and a second end, wherein the first end of the first winding arm is proximate to the base, and wherein the second end is distal from the base; and a second winding arm having a first end and a second end, wherein the first end is proximate to the base, wherein the second end is distal from the base, wherein the second winding arm is rotatable between a collapsed position, a cord-winding position, and a cord-removal position, and wherein the second end of the second winding arm is closer to the base when the second winding arm is in its collapsed position as compared to its cord-removal position or its cord-winding position, wherein the first winding arm and the second winding arm, when in its cord-winding position, are configured to receive the cord such that the cord winds around the first winding arm and the second winding arm, and wherein when in the cord-removal position, the second end of the first winding arm and the second end of the second winding arm are closer to each other than in the cord-winding position. The second end of the second winding arm may be furthest from the first end of the first winding arm when the second winding arm is in its collapsed position, as compared to the cord-winding position and the cord-removal position. A position-regulating mechanism may be configured to stabilize the second winding arm in its cord-removal position. The position-regulating mechanism may be included in the base. The position-regulating mechanism may include a spring arm configured to be selectively positioned in a relaxed state and a compressed state, wherein the spring arm of the position-regulating mechanism is configured to stabilize the second winding arm in its cord-removal position when the spring arm of the position-regulating mechanism is in its compressed state. The spring arm of the position-regulating mechanism may be configured to be in its relaxed state when the second winding arm is in its cord-winding position and its collapsed position. The second winding arm may include a stop configured to engage with the spring arm, such that the second winding arm is prevented from transitioning from its cord-winding position into its cord-removal position when the spring arm of the position-regulating mechanism is in its relaxed state. An angle may be formed between a primary axis of the base and a primary axis of the second winding arm when the second winding arm is in its cord-winding position, wherein the angle is an acute angle. The position-regulating mechanism may include a pair of opposing spring arms, one of which is the spring arm of the position-regulating mechanism, which are configured to operate in an identical, but opposing manner. The base may be elongate and defines an elongate dimension, and the second winding arm may collapse along the elongate dimension. The cord holder may further include a lock configured to maintain the second winding arm in its collapsed position when the lock is locked, and to allow the second winding arm to transition to its cord-winding position or its cord-removal position when the lock is unlocked. The lock may be configured to automatically lock and maintain the second winding arm in its collapsed position when the second winding arm is moved into its collapsed position. The lock may include a spring arm on the second winding arm, wherein the spring arm of the lock is movable between a relaxed state and a compressed state, wherein the spring arm of the lock is configured to be in its relaxed state when the second winding arm is maintained in its collapsed position, and configured to receive a force external to the cord holder to move the spring arm of the lock into its compressed state to move the second winding arm into its cord-winding position or its cord-removal position. The lock may include an opposing spring arm that is configured to operate identically to the spring arm of the lock, but in an opposing manner. The base may include a channel and a plurality of cord retaining portions configured to receive and retain a portion of the cord in the channel. At least one of the first winding arm or the second winding arm may include a recess configured to receive and retain a portion of the cord. The first winding arm may include a recess configured to receive and retain a portion of the cord, and the second winding arm may include a recess configured to receive retain a portion of the cord.

According to embodiments, cord holder for a cord includes: a base; a first winding arm having a first end and a second end, wherein the first end is proximate to the base, wherein the second end is distal from the base, wherein the first winding arm is rotatable between a collapsed position, a cord-winding position, and a cord-removal position, and wherein the second end of the first winding arm is closer to the base when the first winding arm is in its collapsed position as compared to its cord-removal position or its cord-winding position; and a second winding arm having a first end and a second end, wherein the first end is proximate to the base, wherein the second end is distal from the base, wherein the second winding arm is rotatable between a collapsed position, a cord-winding position, and a cord-removal position, and wherein the second end of the second winding arm is closer to the base when the second winding arm is in its collapsed position as compared to its cord-removal position or its cord-winding position, wherein the first winding arm and the second winding arm, when each in their cord-winding position, are configured to receive the cord such that the cord winds around the first winding arm and the second winding arm, and wherein when in the cord-removal position, the second end of the first winding arm and the second end of the second winding arm are closer to each other than in the cord-winding position. The second end of the second winding arm may be furthest from the first end of the first winding arm when the first winding arm and the second winding arm are in their collapsed positions, as compared to being in their cord-winding positions or their cord-removal positions. A first position-regulating mechanism may be configured to stabilize the first winding arm in its cord-removal position, and a second position-regulating mechanism may be configured to stabilize the second winding arm in its cord-removal position. The first position-regulating mechanism and the second position-regulating mechanism may be included in the base. The first position-regulating mechanism may include a spring winding arm configured to be selectively positioned in a relaxed state and a compressed state, wherein the spring winding arm of the first position-regulating mechanism may be configured to stabilize the first winding arm in its cord-removal position when the spring winding arm of the first position-regulating mechanism is in its compressed state, and the second position-regulating mechanism includes a spring winding arm configured to be selectively positioned in a relaxed state and a compressed state, wherein the spring arm of the second position-regulating mechanism may be configured to stabilize the second winding arm in its cord-removal position when the spring arm of the second position-regulating mechanism is in its compressed state. The spring arm of the first position-regulating mechanism may be configured to be in its relaxed state when the first winding arm is in its cord-winding position and its collapsed position, and the spring arm of the second position-regulating mechanism may be configured to be in its relaxed state when the second winding arm is in its cord-winding position and its collapsed position. The first winding arm may include a stop that may be configured to engage with the spring arm of the first position-regulating mechanism, such that the first winding arm is prevented from transitioning from its collapsed position into its cord-winding position or its cord-removal position when the spring arm of the first position-regulating mechanism is in its relaxed state, wherein the cord-winding position of the first winding arm is where the first winding arm may be prevented from transitioning to its cord-winding position or its cord-removal position by the stop of the first winding arm, and the second winding arm may include a stop configured to engage with the spring arm of the second position-regulating mechanism, such that the second winding arm is prevented from transitioning from its collapsed position into its cord-winding position or its cord-removal position when the spring arm of the second position-regulating mechanism is in its relaxed state, wherein the cord-winding position of the second winding arm is where the second winding arm is prevented from transitioning to its cord-winding position or its cord-removal position by the stop of the second winding arm. A first angle may be formed between a primary axis of the base and a primary axis of the first winding arm when the first winding arm is in its cord-winding position, wherein the first angle is an acute angle, a second angle may be formed between the primary axis of the base and a primary axis of the second winding arm when the second winding arm is in its cord-winding position, wherein the second angle is an acute angle. The first position-regulating mechanism may include a pair of opposing spring arms, one of which is the spring arm of the first position-regulating mechanism, which are configured to operate in an identical, but opposing manner, and the second position-regulating mechanism may include a pair of opposing spring arms, one of which is the spring arm of the second position-regulating mechanism, which are configured to operate in an identical, but opposing manner. The base may be elongate and defines an elongate dimension, the first winding arm may collapse along the elongate dimension, and the second winding arm may collapse along the elongate dimension. A first lock may be configured to maintain the first winding arm in its collapsed position when the first lock is locked, and to allow the first winding arm to transition to its cord-removal position when the first lock is unlocked, and a second lock may be configured to maintain the second winding arm in its collapsed position when the second lock is locked, and to allow the second winding arm to transition to its cord-removal position when the second lock is unlocked. The first lock may be configured to automatically lock and maintain the first winding arm in its collapsed position when the first winding arm is moved into its collapsed position, and the second lock may be configured to automatically lock and maintain the second winding arm in its collapsed position when the second winding arm is moved into its collapsed position. The first lock may include a spring arm on the first winding arm, wherein the spring arm of the first lock is movable between a relaxed state and a compressed state, wherein the spring arm of the first lock is configured to be in its relaxed state when the first winding arm is maintained in its collapsed position, and configured to receive a force external to the cord holder to move the spring arm of the first lock into its compressed state to move the first winding arm into its cord-winding position and the second lock may include a spring arm on the second winding arm, wherein the spring arm of the second lock is movable between a relaxed state and a compressed state, wherein the spring arm of the second lock is configured to be in its relaxed state when the second winding arm is maintained in its collapsed position, and configured to receive a force external to the cord holder to move the spring arm of the second lock into its compressed state to move the second winding arm into its cord-winding position. The first lock may include an opposing spring arm that is configured to operate identically to the spring arm of the first lock, but in an opposing manner, and the second lock may include an opposing spring arm that is configured to operate identically to the spring arm of the second lock, but in an opposing manner. The base may include a channel and a plurality of cord retaining portions configured to receive and retain a portion of the cord in the channel. At least one of the first winding arm or the second winding arm may include a recess configured to receive and retain a portion of the cord. The first winding arm may include a recess configured to receive and retain a portion of the cord, and the second winding arm may include a recess configured to receive retain a portion of the cord.

### BRIEF DESCRIPTION OF SEVERAL VIEWS OF THE DRAWINGS

FIGS. 1A, 1B, and 1C show a top perspective view, a top plan view, and a bottom plan view of a cord holder in a collapsed arrangement, according to embodiments.

FIGS. 2A and 2B show a top perspective view and a bottom perspective view of the cord holder in a winding arrangement, according to embodiments.

FIG. 2C shows a top perspective view of the cord holder in a cord-winding arrangement with a wound cord, according to embodiments.

FIG. 3 shows a top perspective view of the cord holder in a cord-removal arrangement with a wound cord, according to embodiments.

FIG. 4 is a flowchart for a method of operating a cord holder, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

Embodiments described and depicted herein allow a user to wind a cord around winding arms of a cord holder. After the cord is wound, the user can place the cord holder into a cord-removal arrangement to remove the cord without first unwinding it. The cord holder may further be capable of being positioned into a collapsed arrangement which has a low profile and is convenient and robust when it is transported or moved to a different location. The cord holder can be light weight and portable.

Advantageously, part of the cord can be retained in a channel in the base, regardless of whether the cord is wound around the winding arms or not. Further, when the cord is retained, the winding arms can be in their collapsed position and locked with the base. A user can keep the cord holder attached to (or retaining) the cord whether or not the cord is wound. When a cord is being used, the cord holder can still retain a portion of the cord and the cord holder can have a low profile. When the cord is wound or being wound, the cord holder can still retain a portion of the cord. The cord need not be removed from the cord holder, while still making advantageous use of the cord—e.g., using it as an electrical cord.

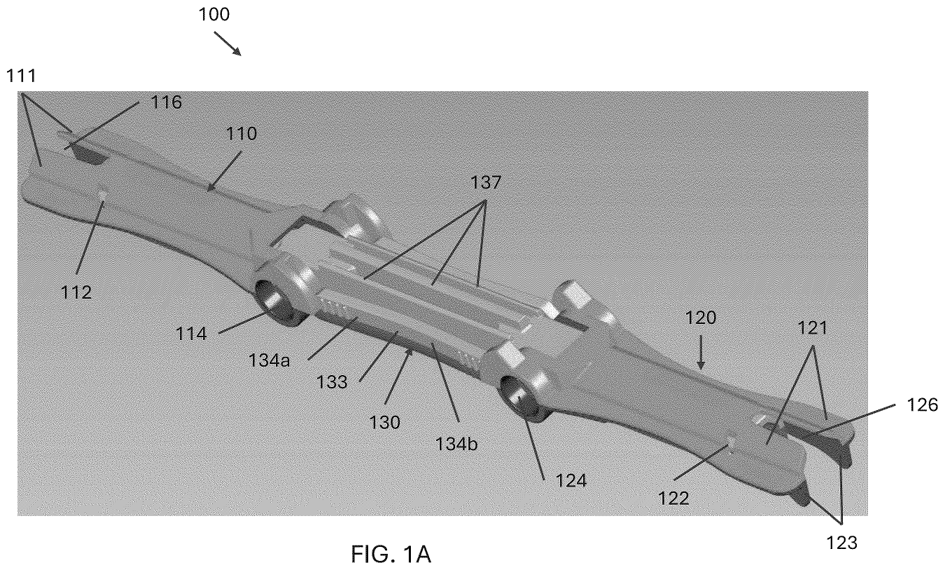

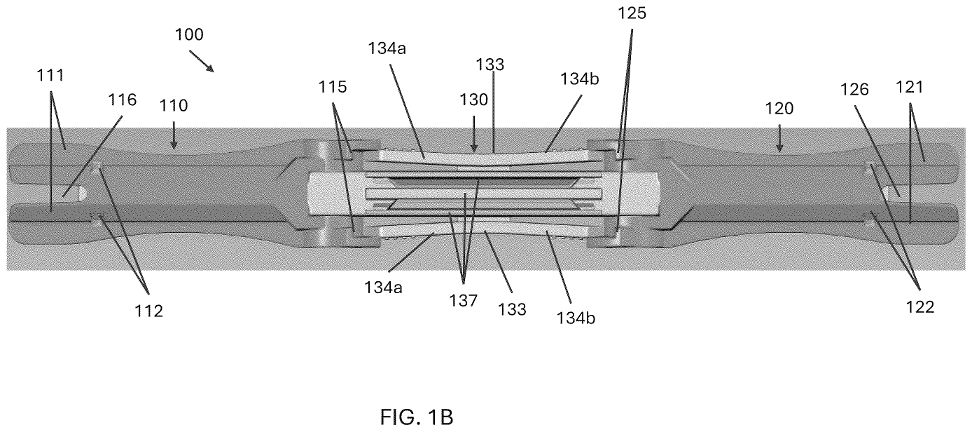

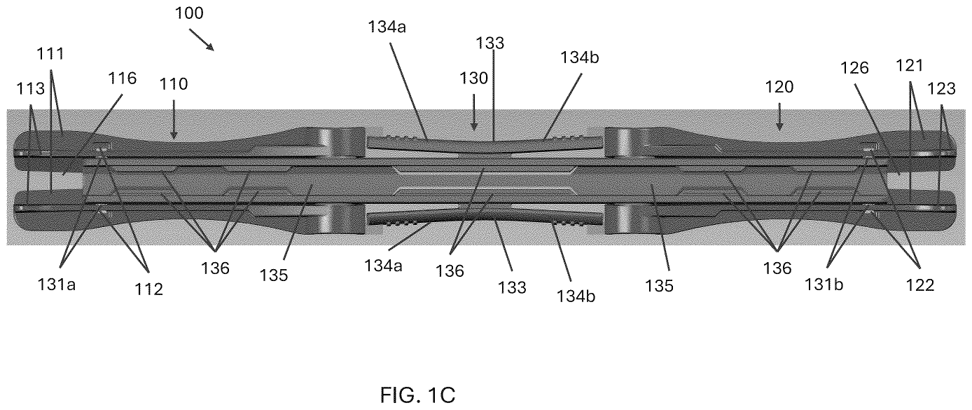

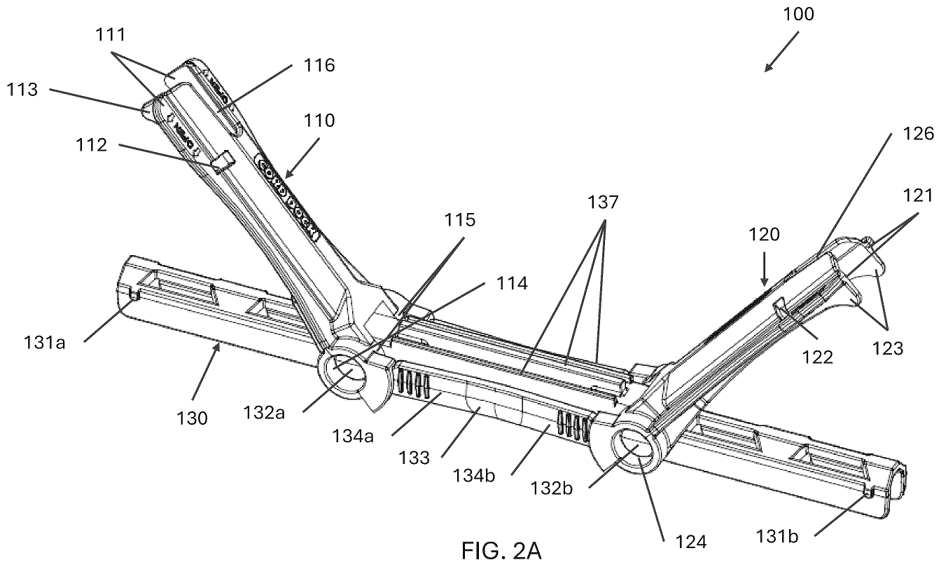

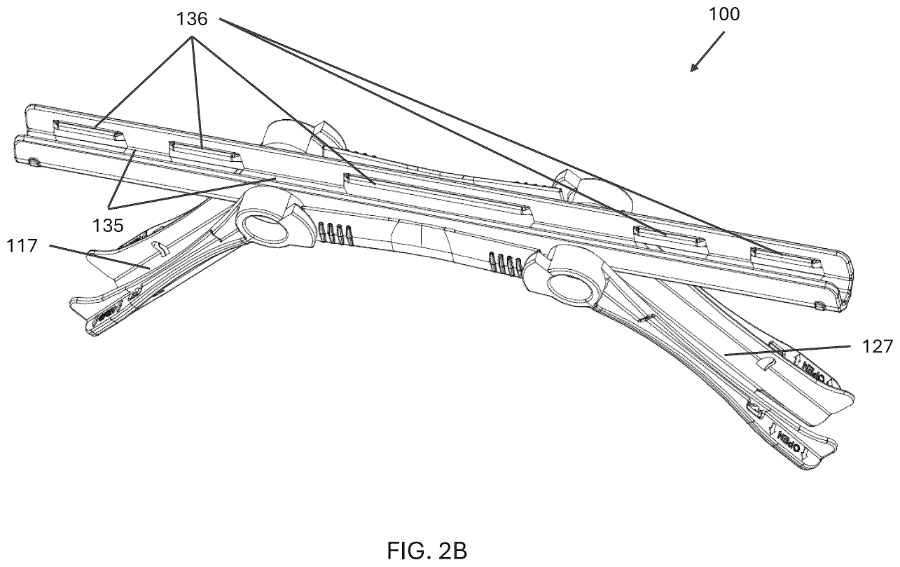

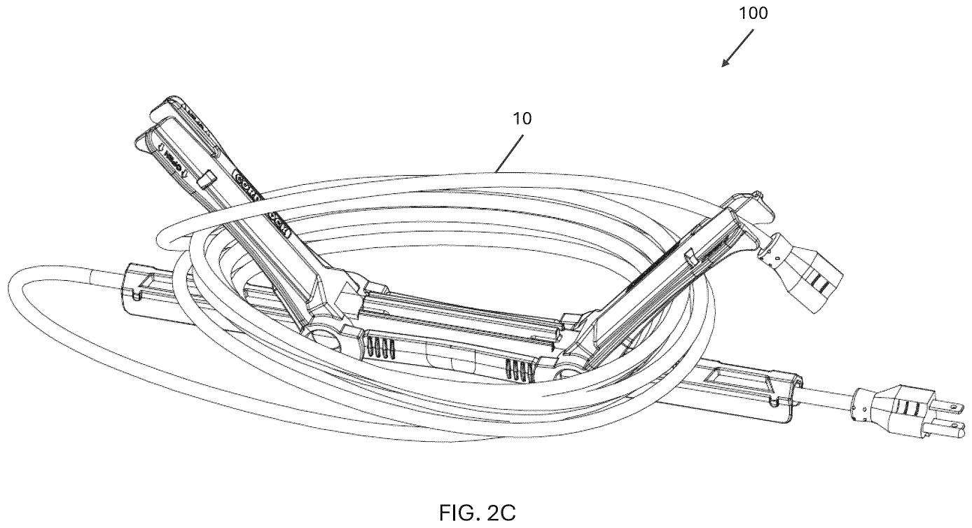

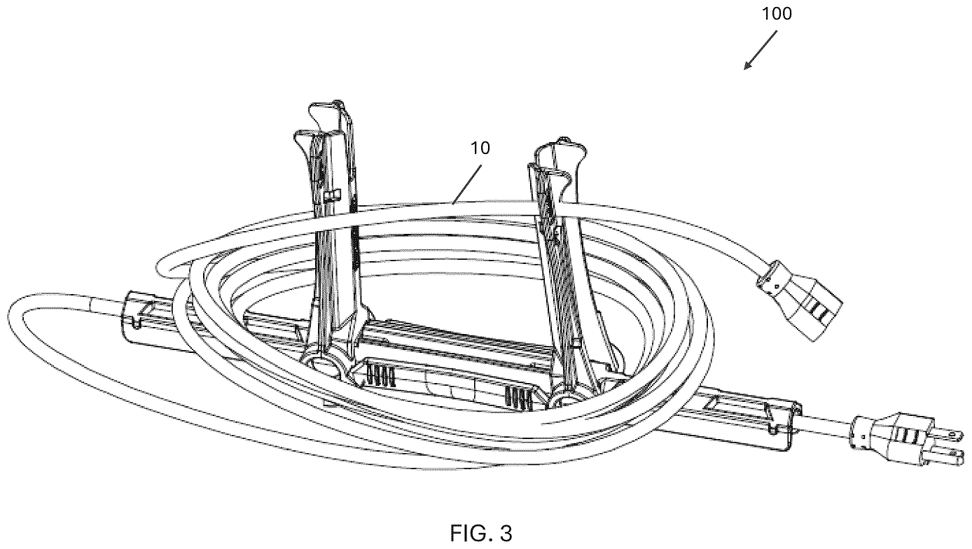

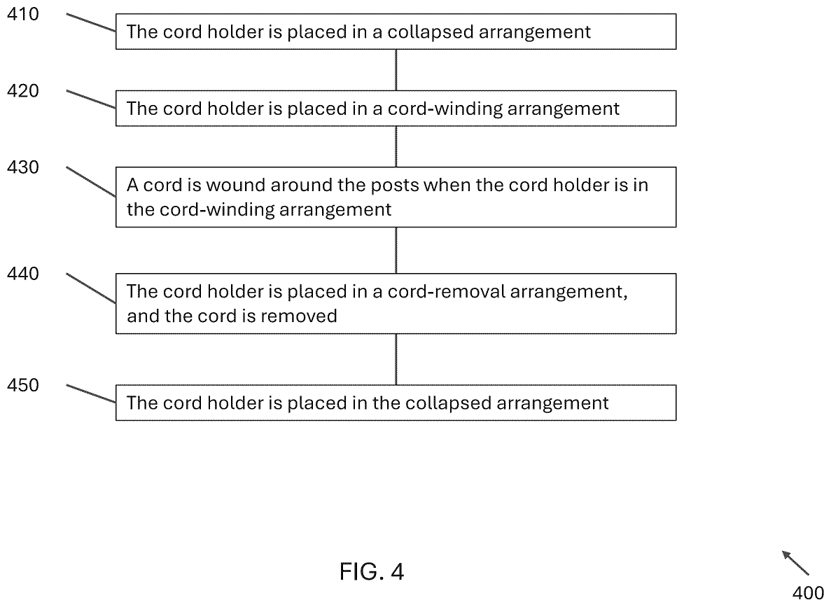

FIGS. 1A, 1B, and 1C show a top perspective view, a top plan view, and a bottom plan view of a cord holder 100 in a collapsed arrangement, respectively, according to embodiments. FIGS. 2A and 2B show a top perspective view and a bottom perspective view of the cord holder 100 in a winding arrangement, according to embodiments. FIG. 2C shows a top perspective view of the cord holder 100 in a cord-winding arrangement with a wound cord 10, according to embodiments. FIG. 3 shows a top perspective view of the cord holder 100 in a cord-removal arrangement with a wound cord 10, according to embodiments. FIG. 4 is a flowchart 400 for a method of operating a cord holder 100, according to embodiments.

The cord holder 100 allows a user to wind a cord 10 (e.g., power cord, strand lights, audio cables, rope, etc.) so it is retained by the cord holder 100. Once retained, the user can engage the cord holder 100 to move it into a position where the cord 10 is removable without having to unwind the cord 10. The cord holder 100 may be portable, or it may be attached or integrated into a non-portable fixture.

As shown in the figures and further described herein, the cord holder 100 can positionable in a collapsed arrangement (FIGS. 1A, 1B), a cord-winding arrangement (FIGS. 2A, 2B, 2C), and a cord-removal arrangement (FIG. 3). In the collapsed arrangement, the winding arms 110, 120 may be horizontal or closer to horizontal, such that the cord holder 100 may not be suitable for allowing a user to wind a cord around the winding arms 110, 120. In the cord-winding arrangement, the winding arms 110, 120 and base 130 are in a suitable arrangement to allow a user to wind the cord 10 such that it is securable on the cord holder 100. In the cord-removal arrangement, a user can remove the cord 10 from the cord holder 100 without having to unwind the cord 10. By “remove”, it is understood that even when the cord 10 is removed, a portion of the cord 10 may still be retained in the channel 135, as further discussed. By “remove” or “removal”, it is understood that the cord 10 is removed from the winding arm(s) 110, 120, and not necessarily from the entire cord holder 100. The cord holder 100 may be configured such that all of these arrangements are not possible. For example, the cord holder 100 may not enable the cord-removal arrangement, in embodiments (not shown). In another example, the cord holder 100 may not enable the collapsed arrangement, in embodiments (not shown). As will be discussed, to effect the different arrangements of the cord holder 100, the winding arm 110 can rotate with respect to the base 130, and the winding arm 120 can rotate with respect to the base 130. Although, only one of the winding arms 110, 120 may be rotatable. For each of the arrangements of the cord holder 100, each winding arm 110, 120 may have a corresponding position. For example, the winding arm 110 may be placed into a collapsed position, a cord-winding position, and/or a cord-removal position. Similarly, the winding arm 120 may be placed into a collapsed position, a cord-winding position, and/or a cord-removal position.

The base 130 may include one or more lock protrusions 131a, 131b, one or more axles 132a, 132b, one or more position-regulating mechanisms 133, one or more spring arms 134a, 134b, a channel 135, and one or more cord-retaining portions 136. The base 130 may be an integrated piece, for example, formed as one piece. The base 130 may be elongate, as shown.

As shown, the base 130 can be generally U-shaped along its width, thereby forming the channel 135. The channel 135 may extend along the entire length of the base 130, or only a portion thereof. The channel 135 may include a plurality of separated regions of the channel 135. On the surface of the channel 135, there may be the cord-retaining portion(s) 136. Each cord-retaining portion 136 can be a protrusion, each extending a distance (or different distances) from a proximate surface of the channel 135. The width of the channel 135 may be between 0.46″ to 0.75″, such as about 0.46″. The height of the channel 135 may be between, for example, 0.80″ to 1.20″, such as about 1″. A cord 10 (e.g., 12, 14, or 16 gauge power cord) can be pressed into the channel 135 and removably retained by the cord-retaining portion(s) 136. The distance between the tips of opposing cord-retaining portions 136 may be between 0.20″ to 0.30″, such as about 0.25″. The width of a given cord-retaining portion 136 can be determined, for example, by subtracting the spacing between cord-retaining portions 136 from the width of the channel 135 and dividing by two. Exemplary widths of cord-retaining portions 136 can be determined this way in accordance with the embodiments above. The width of a cord-retaining portion 136 can be adjusted as part of the molding process. For example, the resins used for injection molding have a shrinkage rate. The temperature used to cool the part can be adjusted to achieve a desired shrinkage rate. The cooler the cooling temperature, the more the material shrinks. If a narrower cord-retaining portion 136 is desired, then a cooler temperature can be used for post-injection cooling. Conversely, if a wider cord-retaining portion 136 is desired, then a warmer temperature can be used for post-injection cooling.

The base 130 may include the lock protrusion 131a, or a plurality of lock protrusions 131a (e.g., a pair of opposing lock protrusion(s) 131a. The lock protrusion(s) 131a may extend outwardly from an outer surface of the channel 135. As shown, there are a pair of lock protrusions 131a symmetrically arranged on the base 130. The lock protrusion(s) 131a may engage with complementary lock aperture(s) 112 on the winding arm 110 as will be further described.

The base 130 may include the lock protrusion 131b, or a plurality of lock protrusions 131b (e.g., a pair of opposing lock protrusion(s) 131b. The lock protrusion(s) 131b may extend outwardly from an outer surface of the channel 135. As shown, there are a pair of lock protrusions 131b symmetrically arranged on the base 130. The lock protrusion(s) 131b may engage with complementary lock aperture(s) 122 on the winding arm 120 as will be further described

The base 130 may include one or more axles 132a extending laterally from the base 130. For example, the base 130 can include a pair of opposing axles 132a extending laterally from the base 130. The axle(s) 132a may engage and operate in conjunction with corresponding hub(s) 114 on the winding arm 110, as will be further described. Each axle 132a may be generally cylindrical. Each axle 132a may include one or more sloped regions on its lateral end, such as two sloped regions forming a V-shape.

The base 130 may include one or more axles 132b extending laterally from the base 130. For example, the base 130 can include a pair of opposing axles 132ba extending laterally from the base 130. The axle(s) 132b may engage and operate in conjunction with corresponding hub(s) 124 on the winding arm 120, as will be further described. Each axle 132b may be generally cylindrical. Each axle 132b may include one or more sloped regions on its lateral end, such as two sloped regions forming a V-shape.

The base may include one or more position-regulating mechanisms 133. For example, the base 130 can include a pair of opposing position-regulating mechanisms 133, for example, symmetrically arranged on opposing lateral sides of the base 130. The position-regulating mechanism(s) 133 may regulate the different arrangements of the cord holder 100 (e.g., collapsed, cord-winding, and/or cord-removal arrangements), as will be further described.

Each position-regulating mechanism 133 may include one or more spring arm(s) 134a. For example, when there are position regulating mechanisms 133 on both sides of the base 130, each may include its own spring arm 134a. There may be a pair of opposing, complimentary spring arms 134a on each side of the base 130, as shown. Each spring arm 134a may be positionable in a compressed state and a relaxed state. According to a spring effect, each spring arm 134a tends to automatically return to its relaxed state under appropriate conditions according to a spring force or constant. In a given compressed state of a spring arm 134a, an end of the spring arm 134a is closer to the main body of the base 130 than when the spring arm 134a is in its relaxed state. The operation of the spring arm(s) 134a will be further discussed, but the spring arm(s) 134a operate to regulate the position of the winding arm 110 in the compressed, cord-winding, and cord removal arrangements.

Each position-regulating mechanism 133 may include one or more spring arm(s) 134b. For example, when there are position regulating mechanisms 133 on both sides of the base 130, each may include its own spring arm 134b. There may be a pair of opposing, complimentary spring arms 134b on each side of the base 130, as shown. Each spring arm 134b may be positionable in a compressed state and a relaxed state. According to a spring effect, each spring arm 134b tends to automatically return to its relaxed state under appropriate conditions according to a spring force or constant. In a given compressed state of a spring arm 134b, an end of the spring arm 134b is closer to the main body of the base 130 than when the spring arm 134b is in its relaxed state. The operation of the spring arm(s) 134b will be further discussed, but the spring arm(s) 134b operate to regulate the position of the winding arm 120 in the compressed, cord-winding, and cord removal arrangements.

The base 130 may further include one or more stops 137, which limit rotation of the winding arm(s) 110, 120 such that a maximum rotation of the winding arm(s) 110, 120 is established. The stop(s) 137 abut a given winding arm 110, 120 when that given winding arm has been rotated to a maximum extent. The stop(s) 137 prevent further rotation.

The winding arm 110 can rotate with respect to the base 130 into a collapsed position, a cord-winding position, and/or a cord-removal position. The winding arm 110 has a first end proximate to the base 130 and a second end distal from the base 130. The winding arm 110 may include one or more spring arms 111, one or more lock apertures 112, one or more tabs 113, one or more hubs 114, one or more stops 115, a recess 116, and/or a recess 117. The winding arm 110 can be lockably secured to the base 130, such that the winding arm 110 cannot be easily removed from the base 130. The winding arm 110 can rotate about the axle(s) 132a. The winding arm 110 may have hub(s) 114 corresponding to the axle(s) 132a. Each hub 114 can have a hollow cylindrical region that receives at least a portion of a corresponding axle 132a. The winding arm 110 may have a pair of opposing hubs 114 on the lateral sides of the winding arm 110.

When the winding arm 110 is in its collapsed position, the recess 117 may receive a corresponding portion of the base. The recess 117 may allow the winding arm 110 to be substantially horizontal or parallel with the base 130. Further, when the winding arm 110 is in its collapsed position, the lock aperture(s) 112 may engage with corresponding lock protrusion(s) 131a. The lock aperture(s) 112 may extend through the thickness of the winding arm 110. Instead of lock aperture(s) 112, the winding arm 110 may have recess(es) on the inner surface of the winding arm 110, receive corresponding lock protrusion(s) 131a into which the protrusion(s) 131a extend. When the lock aperture(s) 112 (or recess(es)) engage with the lock protrusion(s) 131a, the winding arm 110 can be secured to the base 130 in the collapsed position of the winding arm 110. Thus, the lock aperture(s) 112 and corresponding lock protrusion(s) 131a together form a lock, although other locking techniques are contemplated (e.g., latch).

The winding arm 110 may further include one or more spring arms 111 operable to disengage the aforementioned lock. As shown, the winding arm 110 may include a pair of opposing and complimentary spring arms 111 extending to a distal end of the winding arm 110. In between the spring arms 111, a recess 116 may be formed. Such a recess 116 may receive a portion of the cord 10 to retain the cord 10. Each spring arm 111 may include a tab 113 that facilitates a user to engage with the spring arm 111. As shown, the spring arms 111 are in their relaxed state. As the winding arm 110 is moved towards its collapsed position, the lock protrusion(s) 131a may force the corresponding spring arm(s) 111 into a compressed state. As the lock protrusion(s) 131a engage in the lock aperture(s) 112, the spring arm(s) 111 revert to their relaxed state, and the winding arm 110 is locked with the base 130 such that it is maintained in its collapsed position. To unlock the lock, a user can interact with the spring arm(s) 111, for example, via corresponding tab(s) 113, which may extend on the underside of the winding arm 110. The spring arm(s) 112 may be pulled or pushed outwardly by the user (as indicated by the “open” indications in the figures) into their compressed state. While the spring arm(s) 112 are in this compressed state, the user may move or rotate the winding arm 110 away from the base 130, such that the lock protrusion(s) 131a and corresponding lock aperture(s) 112 do not align. Once at a suitable orientation, the user can release the spring arm(s) 111 and allow them to return to their relaxed state. The winding arm 110 may then be rotatable into its cord-winding position or its cord-removal position.

Optionally, a user may be able to unlock the lock without having to manually put the spring arm(s) 111 in a compressed state. The spring arm(s) 111, lock aperture(s) 112, and protrusion(s) 131 may be configured such that a user can pull the winding arm 110 away from the base 130 along the primary rotational direction of the winding arm 110. This pulling force may force the spring arm(s) 111 to compress such that the lock aperture(s) 112 clear the corresponding protrusion(s) 131. The protrusion(s) 131 and lock aperture(s) 112 (or surrounding region) may have complimentary features that force the spring arm(s) 111 laterally when the winding arm 110 is rotated away from the base 130.

Once unlocked, the winding arm 110 may freely rotate in a limited range. This range can be limited by a stop 115 that rotates with the winding arm 110. The stop 115 engages (e.g., abuts) with the base 130 to bring the winding arm 110 into its cord-winding position, although it is possible for any position in this limited range to be a cord-winding position. For example, the stop 115 may engage with the spring arm 134a of the base when the spring arm 134a is in its relaxed state. At the maximum extend of the limited range of rotational movement of the winding arm 110, the primary axis of the winding arm 110 and the primary axis of the base 130 form an acute angle. In this position, the cord 10 can be wound around the winding arm 110 or received by the space formed between the winding arm 110 and the base 130.

The user may further move the winding arm 110 into its cord-removal position. In the cord removal position, the angle between the primary axis of the winding arm 110 and the primary axis of the base 130 is greater than such an angle when the winding arm 110 is in its cord-winding position. The angle for the cord-removal position may be approximately 90 degrees or greater. At such an angle, the cord 10 may be removed from the cord holder 100 (or at least removed from the winding arm 110, e.g., raised above the winding arm 110) without having to first unwind the cord 10.

According to the illustrated embodiment, a space is formed between the end of a given spring arm 134a and the main body of the base 130. When the spring arm 134a is in its relaxed state, a portion of the spring arm 134a engages with the stop 115, and further rotation into the cord-removal position of the winding arm 110 is prevented. The stop 115 may be located such that a space is formed between an inner surface of the stop 115 and an outer surface of the base 130. A user can move the spring arm 134a into its compressed state, and a portion of the spring arm 134a then aligns not with the stop 115, but rather with the space. At this time, the winding arm 110 can be rotated further, and a portion of the spring arm 134a is positioned in the space between the stop 115 and the main body of the base. The winding arm 110 may then be rotated until it encounters the stop(s) 137, at which point further rotational movement of the winding arm 110 with respect to the base is prevented. There may be one stop 137 or multiple stops 137, such as three stops 137 as shown. When the winding arm 110 has been fully rotated and has encountered the stop(s) 137, the winding arm 110 is in its cord-removal position, although the cord-removal position may occur or begin at a rotational location before the maximum extent of rotation.

As explained, when in the winding arm 110 is in its cord-removal position, a given spring arm 134a can be in a compressed state in between a corresponding stop 115 and the main body of the base 130. The spring arm 134a may then exert a force against the winding arm 110, as the spring arm 134a is compressed. This force may stabilize the rotational position of the winding arm 110 with respect to the base 130, such that the winding arm 110 remains non-rotational unless a user or other force engages with the winding arm 110 to rotate it back towards its cord-winding position or its collapsed position. After the winding arm 110 is moved back out of its cord-removal position, it is again in its cord-winding position.

The winding arm 110 may have complimentary features on both sides that function in the aforementioned manner. These complimentary features may include a pair of spring arms 111 and corresponding tabs 113, a pair of lock apertures 112, a pair of hubs 114, and/or a pair of stops 115.

The winding arm 120 may be similar to the winding arm 110 in its construction or operation. The winding arm 120 has a first end proximate to the base 130 and a second end distal from the base 130. The winding arm 120 may include spring arm(s) 121, lock aperture(s) 122, tab(s) 123, hub(s) 124, stop(s) 125, a recess 126, and a recess 127. The spring arm(s) 121 may be similar to the spring arm(s) 111. The lock aperture(s) 122 may be similar to the lock aperture(s) 112, except that they may engage with corresponding lock protrusion(s) 131b. The tab(s) 123 may be similar to the tab(s) 113. The hub(s) 124 may be similar to the hub(s) 114. The stop(s) 125 may be similar to the stop(s) 115. The recess 126 may be similar to the recess 116. The recess 127 may be similar to the recess 117. The winding arm 120 may operate in conjunction with the spring arm(s) 134b instead of the spring arm(s) 134a, although the configuration and/or operation of the spring arm(s) 134b may be similar to that of the spring arm(s) 134a. As these features of the winding arm 120 and the base 130 may be similar, their description is not repeated from the description above with respect to the winding arm 110 and the base 130.

FIG. 4 is a flowchart 400 for a method of operating a cord holder (e.g., the cord holder 100), according to embodiments. The flowchart 400 is described using the cord holder 100 as an example, but is not so-limited. Further, the flowchart 400 is described in an embodiment where there are complimentary features on the cord holder—e.g., complimentary spring arms 111, complimentary lock apertures 112, etc.—although the method can apply to other embodiments of the cord holder 100 where some or all of such features are not complimentary (e.g., there is only one spring arm 111, there is only one lock aperture 112, etc.). The flowchart 500 may be performed by a user engaging with various features of the cord holder 100.

At step 410, the cord holder 100 is placed in a collapsed arrangement. In this arrangement, the winding arm 110 is in its collapsed position and the winding arm 120 is in its collapsed position. When the winding arm 110 is in its collapsed position, the second end of the winding arm 110 is closer to the base 130 than when the winding arm 110 is in its cord-winding position or cord-removal position. The user may rotate the winding arm 110 and the winding arm 120 when there is no cord 10 being held by the cord holder 100 to place the cord holder 100 in its collapsed arrangement. For the winding arm 110, the user can rotate the winding arm 110 such that it automatically snaps in to the lock protrusion(s) 131a. As the user rotates the winding arm 110 into its collapsed position, the locking may take place automatically (e.g., no need for the user to engage with the spring arms 111 or tabs 113 extending therefrom. The winding arm 120 can be placed in its collapsed position in a similar manner as with that of the winding arm 110, and the description will not be repeated. When the winding arm 120 is in its collapsed position, the second end of the winding arm 120 is closer to the base 130 than when the winding arm 120 is in its cord-winding position or cord-removal position. When the winding arm 110 and the winding arm 120 are in their collapsed positions, these components and the base 130 may all be in a horizontal arrangement, with the winding arms 110, 120. When the cord holder 100 is in its collapsed arrangement, the first end of the winding arm 110 is closer to the first end of the winding arm 120 as compared to the distance between the second end of the winding arm 110 and the second end of the winding arm 120. The cord holder 100 may further have a low profile, especially when the winding arm 110 receives a portion of the base 130 in the recess 117, and when the winding arm 120 receives a portion of the base 130 in the recess 127.

At step 420, the cord holder 100 is placed in a cord-winding arrangement. First, the winding arm 110 can be unlocked from the base 130 such that it can rotate. The user engages with the spring arms 111 (e.g., via the tabs 113) to spread them apart from each other. As the spring arms 111 are spread apart, the lock apertures 112 are repositioned with respect to the lock protrusions 131a. After this repositioning, the lock protrusions 131a can separate from the lock apertures 112, and the winding arm 110 can rotate. The same process is performed on the winding arm 120 with corresponding features: spring arms 121, tabs 123, lock apertures 122, and the lock protrusions 131b. In the cord-winding arrangement, the winding arms 110, 120 can each freely rotate between their collapsed positions and where the stops 115, 125 inhibit further rotation when the spring arms 134a, 134b are in their relaxed state.

At step 430, the user winds the cord 10 or otherwise arranges the cord 10 on the cord holder 100. The user can start by inserting a portion of the cord 10 into the channel 135 of the base 130. The user can push the cord into the channel 135 such that the cord retaining portions 136 retain the cord 10 in the channel 135 by engaging with the cord 10 and inhibiting it from coming out of the channel 135 without application of a substantial force (e.g., a force stronger than gravity acting on the cord 10). The user can then wind the cord around the winding arms 110, 120. After the cord 10 is almost fully wound (or at any time during the winding process), the user can then secure the end of the cord 10 by placing it in either the recess 116 or the recess 126.

At step 440, the cord holder 100 is placed in the cord-removal arrangement. The user can depress spring arm(s) 134a and rotate the winding arm 110 into its cord-removal position. The user can further depress spring arm(s) 134b and rotate the winding arm 120 into its cord-removal position. The user can further remove the cord 10 from the channel 135 and from the recess 116 or 126. The cord 10 can then be removed from the cord holder 100. Optionally, the cord 10 can continue to be retained in the channel 135 after the cord has been removed from the winding arms 110, 120.

At step 450, the cord holder 100 can again be placed in the collapsed arrangement. The winding arm 110 can be rotated out of its cord-removal position, through its cord-winding position, and into its collapsed position without needing to engage any other portion of the cord holder 100. The winding arm 120 can be rotated out of its cord-removal position, through its cord-winding position, and into its collapsed position without needing to engage any other portion of the cord holder 100. A portion of the cord 10 can still be retained in the channel 135 when the cord holder 100 is in the collapsed arrangement.

### PARTS LIST

| Part No. | Part |
|---|---|
| 10 | Cord |
| 100 | Cord holder |
| 110 | Winding arm |
| 111 | Spring arm |
| 112 | Lock aperture |
| 113 | Tab |
| 114 | Hub |
| 115 | Stop |
| 116 | Recess |
| 117 | Recess |
| 120 | Winding arm |
| 121 | Spring arm |
| 122 | Lock aperture |
| 123 | Tab |
| 124 | Hub |
| 125 | Stop |
| 126 | Recess |
| 127 | Recess |
| 130 | Base |
| 131a | Lock protrusion |
| 131b | Lock protrusion |
| 132a | Axle |
| 132b | Axle |
| 133 | Position-regulating mechanism |
| 134a | Spring arm |
| 134b | Spring arm |
| 135 | Channel |
| 136 | Cord-retaining portion |
| 137 | Stop |

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A cord holder for a cord, the cord holder comprising:
a base;
a first winding arm having a first end and a second end, wherein the first end of the first winding arm is proximate to the base, and wherein the second end is distal from the base; and
a second winding arm having a first end and a second end, wherein the first end is proximate to the base, wherein the second end is distal from the base, wherein the second winding arm is rotatable between a collapsed position, a cord-winding position, and a cord-removal position, and wherein the second end of the second winding arm is closer to the base when the second winding arm is in its collapsed position as compared to its cord-removal position or its cord-winding position,
wherein the first winding arm and the second winding arm, when in its cord-winding position, are configured to receive the cord such that the cord winds around the first winding arm and the second winding arm, and
wherein when in the cord-removal position, the second end of the first winding arm and the second end of the second winding arm are closer to each other than in the cord-winding position.

2. The cord holder of claim 1, wherein the second end of the second winding arm is furthest from the first end of the first winding arm when the second winding arm is in its collapsed position, as compared to the cord-winding position and the cord-removal position.

3. The cord holder of claim 1, further comprising a position-regulating mechanism configured to stabilize the second winding arm in its cord-removal position.

4. The cord holder of claim 3, wherein the position-regulating mechanism is included in the base.

5. The cord holder of claim 3, wherein the position-regulating mechanism includes a spring arm configured to be selectively positioned in a relaxed state and a compressed state, wherein the spring arm of the position-regulating mechanism is configured to stabilize the second winding arm in its cord-removal position when the spring arm of the position-regulating mechanism is in its compressed state.

6. The cord holder of claim 5, wherein the spring arm of the position-regulating mechanism is configured to be in its relaxed state when the second winding arm is in its cord-winding position and its collapsed position.

7. The cord holder of claim 5, wherein the second winding arm includes a stop configured to engage with the spring arm, such that the second winding arm is prevented from transitioning from its cord-winding position into its cord-removal position when the spring arm of the position-regulating mechanism is in its relaxed state.

8. The cord holder of claim 1, wherein an angle is formed between a primary axis of the base and a primary axis of the second winding arm when the second winding arm is in its cord-winding position, wherein the angle is an acute angle.

9. The cord holder of claim 7, wherein the position-regulating mechanism includes a pair of opposing spring arms, one of which is the spring arm of the position-regulating mechanism, which are configured to operate in an identical, but opposing manner.

10. The cord holder of claim 1, wherein the base is elongate and defines an elongate dimension, and the second winding arm collapses along the elongate dimension.

11. The cord holder of claim 1, further including a lock configured to maintain the second winding arm in its collapsed position when the lock is locked, and to allow the second winding arm to transition to its cord-winding position or its cord-removal position when the lock is unlocked.

12. The cord holder of claim 11, wherein the lock is configured to automatically lock and maintain the second winding arm in its collapsed position when the second winding arm is moved into its collapsed position.

13. The cord holder of claim 1, wherein the base includes a channel and a plurality of cord retaining portions configured to receive and retain a portion of the cord in the channel.

14. The cord holder of claim 1, wherein at least one of the first winding arm or the second winding arm includes a recess configured to receive and retain a portion of the cord.

15. A cord holder for a cord, the cord holder comprising:
a base;
a first winding arm having a first end and a second end, wherein the first end is proximate to the base, wherein the second end is distal from the base, wherein the first winding arm is rotatable between a collapsed position, a cord-winding position, and a cord-removal position, and wherein the second end of the first winding arm is closer to the base when the first winding arm is in its collapsed position as compared to its cord-removal position or its cord-winding position; and
a second winding arm having a first end and a second end, wherein the first end is proximate to the base, wherein the second end is distal from the base, wherein the second winding arm is rotatable between a collapsed position, a cord-winding position, and a cord-removal position, and wherein the second end of the second winding arm is closer to the base when the second winding arm is in its collapsed position as compared to its cord-removal position or its cord-winding position,
wherein the first winding arm and the second winding arm, when each in their cord-winding position, are configured to receive the cord such that the cord winds around the first winding arm and the second winding arm, and
wherein when in the cord-removal position, the second end of the first winding arm and the second end of the second winding arm are closer to each other than in the cord-winding position.

16. The cord holder of claim 15, wherein the second end of the second winding arm is furthest from the first end of the first winding arm when the first winding arm and the second winding arm are in their collapsed positions, as compared to being in their cord-winding positions and their cord-removal positions.

17. The cord holder of claim 15, further comprising:
a first position-regulating mechanism configured to stabilize the first winding arm in its cord-removal position; and
a second position-regulating mechanism configured to stabilize the second winding arm in its cord-removal position.

18. The cord holder of claim 15, wherein:
a first angle is formed between a primary axis of the base and a primary axis of the first winding arm when the first winding arm is in its cord-winding position, wherein the first angle is an acute angle; and
a second angle is formed between the primary axis of the base and a primary axis of the second winding arm when the second winding arm is in its cord-winding position, wherein the second angle is an acute angle.

19. The cord holder of claim 15, further including:
a first lock configured to maintain the first winding arm in its collapsed position when the first lock is locked, and to allow the first winding arm to transition to its cord-removal position when the first lock is unlocked; and
a second lock configured to maintain the second winding arm in its collapsed position when the second lock is locked, and to allow the second winding arm to transition to its cord-removal position when the second lock is unlocked.

20. The cord holder of claim 19, wherein:
the first lock is configured to automatically lock and maintain the first winding arm in its collapsed position when the first winding arm is moved into its collapsed position; and
the second lock is configured to automatically lock and maintain the second winding arm in its collapsed position when the second winding arm is moved into its collapsed position.
